(19) United States
(12) Patent Application Publication
(10) Pub. No.: US 2004/0028958 A1
(43) Pub. Date: Feb. 12, 2004

(54) Recyclable fire-resistant moldable batt and panels formed therefrom

(75) Inventors: Kenneth Assink, Holland, MI (US); Teresa M. Donnay Heger, Grand Haven, MI (US); Jack Frick, Hudsonville, MI (US); Dennis J. Beard, Holland, MI (US)

Correspondence Address: Mark E. Bandy, Esq., Fay, Sharpe, Fagan, Minnich & McKee, LLP, Seventh Floor, 1100 Superior Avenue, Cleveland, OH, 44114-2579, US

(73) Assignee: Total Innovative Manufacturing LLC

(21) Appl. No.: 10/463,187

(22) Filed: Jun. 17, 2003

Related U.S. Application Data
(60) Provisional application No. 60/389,647, filed on Jun. 18, 2002.

(51) Int. Cl. D04H 1/00; B32B 27/04; D04H 1/54; B29C 70/06

(52) U.S. Cl. 428/920; 442/149; 442/361; 442/415; 442/409; 442/411; 264/122; 264/123

(57) ABSTRACT

A moldable batt is disclosed that comprises a fire-retardant cellulose, a fiber component, and a binder component. In one version of the invention, the fiber and binder components are provided as a conjugate fiber material. The batt is compressed and heated to form panels or other products that are particularly useful in the office furniture industry.

### CROSS REFERENCES TO RELATED APPLICATIONS

This application claims priority from U.S. provisional application Serial No. 60/389,647 filed Jun. 18, 2002. This application also claims priority from U.S. application Ser. No. 09/869,418 filed Jun. 27, 2001 which claims priority from PCT/US00/32272 filed Nov. 21, 2000, which in turn claims priority from U.S. provisional application Serial No. 60/167,303 filed Nov. 24, 1999.

### BACKGROUND OF THE INVENTION

In the office landscape environment, much of the furniture, including partition walls, insert panels and furniture panels are often made with fiberglass as a primary component. While providing good fire-retardant properties, office panels made with fiberglass fibers emit phenol compounds and other gasses from the resins that hold the fiber together. This, along with other health adverse properties, generally renders fiberglass panels undesirable in office environments.

Panels that utilize one or more layers of a foamed polymer are also well known in the art. Such panels may be designed to provide excellent insulating and sound barrier properties. However, many foam based materials are not fire-retardant. Furthermore, nearly all foamed materials lack the strength and rigidity requirements demanded by furniture applications. Accordingly, there is a need for a non-foam based structure that avoids the previously noted problems associated with fiberglass constructions.

One alternate approach noted in the art is to mold or thermoform a non-woven fibrous web or batt into a desired shape. The batt is free of fiberglass fibers and upon being subjected to a molding or thermoforming operation, is formed into a panel of desired density and strength. Although satisfactory in numerous respects, as far as is known panels formed using this approach do not exhibit fire-retardancy properties. Moreover, the batts from which these panels are formed are relatively expensive. Furthermore, it would be desirable to produce such panels with specific densities and strength characteristics compatible with furniture assembly system requirements.

### SUMMARY OF THE INVENTION

In a first aspect, the present invention provides a panel adapted for use in a furniture assembly. The panel comprises a first face, a second face opposite the first face, and a non-woven fibrous body disposed between the two faces. The fibrous body includes (i) from about 15% to about 60% of a fiber component dispersed throughout the body, (ii) from about 15% to about 85% of a fire-retardant cellulose component dispersed throughout the body, and (iii) from about 15% to about 70% of a binder component dispersed throughout the body. The body includes a plurality of fused regions of contact defined between adjacent portions of binder component resulting from prior heating of the body to a temperature sufficient to cause at least partial melting of the binder component and thereby fuse adjacent portions of the binder component. The panel exhibits a flame spread index of 25 or less, and a smoke index of 450 or less.

In another aspect, the present invention provides a panel adapted for use in the furniture assembly. The panel comprises a first surface, a second surface opposite the first surface, and a fibrous body disposed between the two surfaces. The fibrous body includes (i) from about 40% to about 70% of a fire-retardant cellulose component, and (ii) from about 30% to about 60% of a bi-component fiber. The bi-component fiber has an inner portion of a first thermoplastic and an outer portion of a second thermoplastic. The second thermoplastic has a melting point temperature less than the melting point temperature of the first thermoplastic. The body includes a plurality of fused regions of contact defined between adjacent bi-component fibers resulting from prior heating of the body to a temperature greater than the melting temperature of the second thermoplastic. The panel has fire-retardancy properties such that the panel exhibits a flame spread index of 25 or less and a smoke index of 450 or less.

In yet another aspect, the present invention provides a fire-resistant moldable batt comprising (i) from about 15% to about 60% of a fiber component, (ii) from about 15% to about 85% of a fire-retardant cellulose component, and (iii) from about 15% to about 70% of a binder component. The cellulose component is treated with at least one of boric acid or sodium polyborate. The binder component is a thermoplastic having a melting point of from about 100° C. to about 185° C.

In yet another aspect, the present invention provides a process for producing a panel in which the process includes providing from about 15% to about 60% by weight of the panel of a fiber component. The process also comprises a step of providing from about 15% to about 85% by weight of the panel of a fire-retardant cellulose component. The process additionally comprises a step of providing from about 15% to about 70% by weight of the panel of a binder component. The process further includes a step of dispersing together the fiber component, the cellulose component, and the binder component to form a non-woven fibrous batt having a plurality of regions of contact between adjacent portions of binder component. The process includes a step of further forming the non-woven fibrous batt by compressing the batt to a density of from about 2.5 lbs/ft³ to about 14.8 lbs/ft³, and heating the batt to a temperature greater than the melting temperature of the binder component to thereby fuse together the regions of contact between adjacent binder portions and form the panel.

In yet another aspect of the present invention, the present invention provides a process for producing a panel comprising a step of providing from about 40% to about 70% by weight of the panel of a cellulose component. The process also includes a step of providing from about 30% to about 60% by weight of the panel of a conjugate fiber. The conjugate fiber has a first portion of a first thermoplastic and a second portion of a second thermoplastic having a melting temperature less than the melting temperature of the first thermoplastic. The process also includes a step of dispersing together the cellulose component and the conjugate fiber to form a non-woven fibrous batt having a plurality of regions of contact between adjacent conjugate fibers. The process further includes a step of heating and compressing the non-woven fibrous batt by compressing the batt to a density of from about 2.5 lbs/ft³ to about 14.8 lbs/ft³, and a temperature greater than the melting temperature of the second thermoplastic to thereby fuse together regions of contact between adjacent conjugate fibers and thereby form the panel.

### BRIEF DESCRIPTION OF THE DRAWINGS

The present invention will be described in detail with several preferred embodiments and illustrated, merely by way of example and not with intent to limit the scope thereof, in the accompanying drawings.

FIG. 1 is a cross-sectional view of a preferred embodiment furniture panel according to the present invention.

FIG. 2 is a perspective view of a portion of a bi-component fiber suitable for use in the present invention.

FIG. 3 is a step diagram illustrating a preferred embodiment process for producing a furniture panel according to the present invention.

FIG. 4 is a perspective view of a storage cabinet having a preferred embodiment door panel according to the present invention.

FIG. 5 is a cross-sectional view of another preferred embodiment door panel according to the present invention adapted for use with a pre-existing door.

FIG. 6 is a graph illustrating the results of flame spread and smoke development testing for a preferred embodiment panel according to the present invention.

FIG. 7 is a graph illustrating the results of flame spread and smoke development testing for a preferred embodiment panel according to the present invention.

### DETAILED DESCRIPTION OF THE PREFERRED EMBODIMENTS

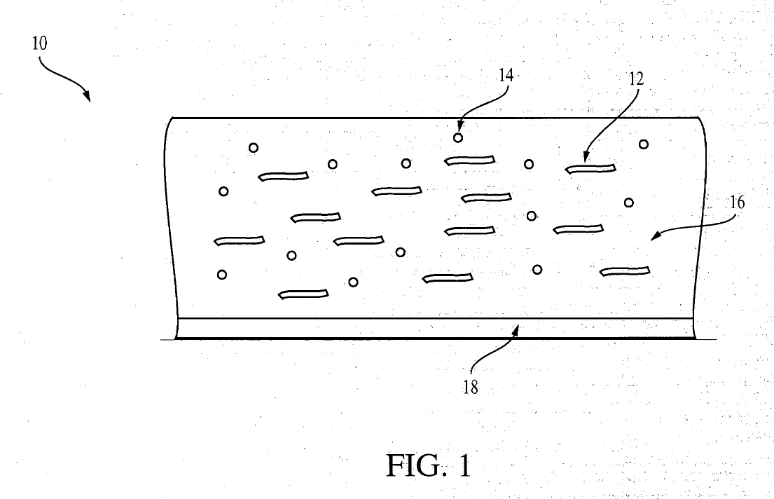

A cross-sectional view of a furniture panel according to a preferred embodiment of the present invention is generally shown in FIG. 1. A furniture or decorative panel according to the invention may be formed with any of various configurations as dictated by the specific use requirements of a given office landscape system. Thus, a furniture or decorative panel according to the invention can take various forms including, but not limited to, flipper doors, wall panels, tack boards, seat back panels, mobile storage cabinets, backboards, light shields, divider screens, modesty panels and shelf panels.

The preferred embodiment furniture panel 10 is a unified or monolithic member and includes a fiber component 12, a cellulose component 14, a binder component 16 that acts as an adhesive to bind the components 12 and 14 together, and, optionally, a finish material 18 embedded or otherwise retained on the surface of the panel. The panel 10 may also include various fillers and additional materials as well. The various components are assembled into a non-woven web or batt, processed, and melt-bonded together to form a finished panel. The terms “batt” and “web” are used herein and generally refer to a layer of randomly oriented, i.e. non-woven, fibers or elongated strands of materials, that when in such a form exhibit a relatively low density, high insulating qualities, and a loose and flexible structure. The terms “batt” and “web” encompass such layers that contain, in addition to fibrous or strand-like materials, minor amounts of materials in other forms such as particles, flakes, and liquid, viscous, or semi-solid components. Specifically, a “web” refers to a relatively thin layer of randomly oriented fibers that upon sufficient build-up or successive deposition onto other web(s), form a “batt.” These aspects are described in greater detail herein.

The fiber component 12 for use in the preferred embodiment batt and panel provides structure and strength characteristics to the resulting panel. Preferably, the fiber component constitutes from about 15% to about 60% of the batt (all percentages are weight percentages unless indicated otherwise). The fiber preferably has a diameter of from about 1.5 to about 66 denier and most preferably from about 6 to about 40 denier. The fiber 12 is preferably formed from a high melting point thermoplastic polymer. A listing of preferred materials is provided herein. Any thermoplastic used as the fiber 12 should preferably have a melting point higher than the temperatures used in the production of the furniture panel as described herein. That is, while it is acceptable for the fiber 12 used in the present invention to become soft during the molding or panel forming process, it should not melt to the extent of flowing or losing its structure completely. More than one type of fiber may be used in the construction of a panel according to the present invention. Alternately or in addition to the thermoplastic fiber, natural fibers could be used to serve, at least in part, as fiber 12, such as sisal fiber, jute fiber, kenaf fiber, coconut fiber, corn fiber, soybean fiber, wool fiber, cotton fiber, or hemp fiber. In addition, it is contemplated that fibers containing aramid or rayon materials, or carbon fibers could be used as fiber 12.

The cellulose component 14 of the preferred embodiment batt and panel is used to provide mass and shape to the furniture panel as well as contribute to its fire resistance or fire-retardancy properties. Preferably, the cellulose that is utilized in the preferred embodiment batt and panel is recycled cellulose. Examples of recycled cellulose include recycled cellulose from newspapers or other paper products. The use of recycled cellulose significantly reduces the costs in forming the various preferred batts and panels. To increase its fire resistance, the cellulose is treated with a fire-retardant in an amount necessary to render it nonflammable or substantially so. Suitable fire retardants include, but are not limited to, boric acid and/or sodium polyborate. A preferred sodium polyborate is commercially available under the designation Boron 10™. It is also contemplated that a wide array of other fire retardants may be used in forming the preferred embodiment batt and panel. For instance, effective amounts of ammonium sulfate may be incorporated in the batt or panel. Treated cellulose may also be purchased from commercial suppliers. Suitable commercially available treated cellulose fiber for use in the present invention includes NU-WOOL®, available from Nu-Wool Co., Inc. and boron cellulose available under the tradename THERMOLOK INCIDE™ from Hamilton Mfg. Inc. Although a wide array of cellulose or cellulose-based materials may be used for the cellulose component, it is preferred that the cellulose component have a density of about 25.6 kg/m³ (1.6 lbs/ft³). It will be understood, however, that the present invention includes a wide range of densities greater than and lesser than this preferred value. The cellulose component preferably constitutes from about 15% to about 85%, more preferably from about 40% to about 70%, and most preferably 45% to 55% by weight of the batt.

The binder component 16 of the preferred embodiment batt and panel acts as an adhesive and binder to bond the fiber component 12 and cellulose component 14 together and lock the fiber and cellulose into a relatively rigid configuration. Thus, the binder component at least partially melts during the molding or panel forming process. Preferably, the binder component constitutes from about 15% to about 70% of the batt. The binder component can be any thermoplastic having this characteristic, such as for example, polyester, polyethylene terephthalate (PET), polypropylene, polyethylene, nylon, polylactide, and acrylic. A particularly preferred polylactide is PLA™ available from Cargill Dow Polymers. PLA™ is a polylactide polymer formed from corn-derived dextrose. A listing of other preferred thermoplastic materials is provided herein. The binder component can be in nearly any form including, but not limited to fiber, flake, particle, pellet, and as a coating on one or both of the other components. It is also contemplated that certain hot-melt adhesives, such as polyethylene-, polyamide-, polyester- and ethylene-vinyl acetate copolymer-based hot-melt adhesives may be used in conjunction with the binder component. The adhesives are selected to have a melting point below the melting point of the fiber component. Preferably, the binder component is a polyester having a melting point of from about 100° C. (212° F.) to about 185° C. (365° F.). During the process of panel formation, the binder component at least partially melts and becomes flowable, penetrating between the fibers or fiber component and the cellulose component to bond them together. Upon cooling, the binder component solidifies.

The present invention batts and panels preferably utilize a relatively high proportion of binder component. This relatively large proportion contributes, along with other features and aspects described herein, to properties of the resulting panels that render such panels suitable for use in furniture systems. One important characteristic is the resulting strength characteristics of panels formed from the batts described herein. It is believed that the relatively high proportion of binder component imparts greater strength and load-bearing properties to the resulting panels.

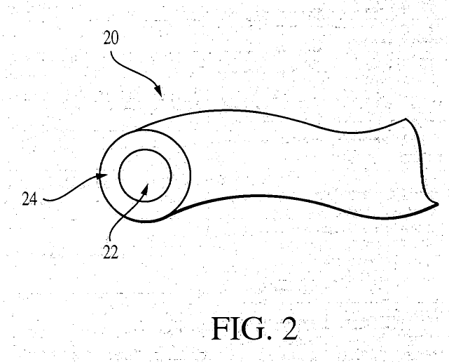

In one embodiment of the present invention, as illustrated in FIG. 2, the fiber component and the binder component are provided as a single bi-component blended fiber 20. In this bi-component or conjugate fiber, the two materials may be arranged in co-axial arrangement, with an inner strand 22 of higher melting point fiber, such as fiber 12, surrounded by a sheath 24 of lower melting point binder polymer, such as binder component 16. Suitable polyester bi-component fibers for use in the present invention are commercially available under the trade designation “PET bi-component fiber” from various manufacturers. Various sized bi-component fibers 20 may be used in the present invention batt or panel depending on the particular use. Although not intended to be limiting, a typical bi-component fiber suitable for use in most applications of the present invention has a diameter of about 9 denier or smaller, preferably about 7 denier or smaller, and most preferably from about 1.5 to about 5 denier. When bi-component fiber is used, a preferred batt according to the present invention contains from about 30% to about 60% by weight bi-component fiber and from about 40% to about 70% by weight cellulose component. In any event, the amount should be such that the resultant panel will pass ASTM E84 flame test for building materials and UL 723 test. This is described in greater detail herein.

Monocomponent and bi-component fibers suitable for the present invention batts and panels may be produced from a wide variety of thermoplastic polymers that are used to form fibers. Desirably, when bi-component fibers are utilized, the component polymers are selected in accordance with the above-described selection criteria including melting point properties. Suitable polymers for the present invention include, but are not limited to, polyolefins, e.g., polyethylene, polypropylene, polybutylene and the like; polyamides, e.g., nylon 6, nylon 6/6, nylon 10, nylon 12 and the like; polyesters, e.g., polyethylene terephthalate, polybutylene terephthalate and the like; polycarbonates; polystyrenes; thermoplastic elastomers, e.g., ethylene-propylene rubbers, polyurethane, styrenic block copolymers, copolyester elastomers and polyamide elastomers and the like; fluoropolymers, e.g., polytetrafluoroethylene and polytrifluorocholoroethylene; vinyl polymers, e.g., polyvinyl chloride; and blends and copolymers thereof. Particularly suitable polymers for the present invention are polyolefins, including polyethylene, e.g., linear low density polyethylene, low density polyethylene, medium density polyethylene, high density polyethylene and blends thereof; polypropylene; polybutylene; and copolymers as well as blends thereof. Of the suitable polymers, particularly suitable polymers for the high melting component of conjugate fibers include polypropylene, copolymers of polypropylene and ethylene and blends thereof, more particularly polypropylene, and particularly suitable polymers for the low melting component include polyethylenes, more particularly linear low density polyethylene, high density polyethylene and blends thereof. In addition, the polymer components may contain additives or thermoplastic elastomers for enhancing certain physical properties such as lowering the bonding temperature of the fibers, and enhancing the abrasion resistance, strength and softness of the resulting webs. For example, the binder polymer component may contain about 5% to about 20% by weight of a thermoplastic elastomer such as an ABA′ block copolymer of styrene, ethylene-butylene and styrene. Such copolymers are commercially available and some of which are identified in U.S. Pat. No. 4,663,220 to Wisneski et al, herein incorporated by reference. An example of highly suitable elastomeric block copolymers is KRATON G-2740. Another group of suitable additive polymers is ethylene alkyl acrylate copolymers, such as ethylene butyl acrylate, ethylene methyl acrylate and ethylene ethyl acrylate, and the suitable amount to produce the desired properties is from about 2% to about 50%, based on the total weight of the binder component. Yet other suitable additive polymers include polybutylene copolymers and ethylenepropylene copolymers.

When utilizing a bi-component or conjugate fiber, it will be appreciated that the lower melting component, e.g. the binder component, can be melted and thus rendered flowable while allowing the higher melting component, e.g. the fiber component, to maintain the physical integrity and structure of the batt or non-woven web. The melted binder component adheres to adjacent fibers or components, especially at the cross-over or contact points. Consequently, the melting point difference between the binder component and the fiber component is at least about 5° C. (9° F.), preferably at least about 10° C. (18° F.), and more preferably at least about 25° C. (45° F.). These temperature differences also apply to batts formed from separate populations of fiber component and binder component, i.e. and not utilizing bi-component or conjugate fiber. In one embodiment of the present invention, it is preferred to utilize a bi-component fiber having a polyethylene terephthalate (PET) core, and most preferably, for such PET core to have a melting temperature of about 260° C. (500° F.). Furthermore, although a wide array of bi-component fibers may be used, it is preferred that the bi-component fiber have a density of from about 1.25 g/cm³ to about 1.33 g/cm³. Suitable bi-component fibers should have the binder component at least partially exposed to the surface along substantially the entire length of the fibers. Particularly preferred bi-component fibers have from about 20% to about 80%, preferably from about 40% to about 60%, and most preferably about 50% by weight of the binder component with the remainder being the fiber component. For the present invention, desirable configurations for the bi-component fibers include side-by-side configurations and sheath-core configurations, and suitable sheath-core configurations include eccentric sheath-core and concentric sheath-core configurations. A concentric configuration is depicted in FIG. 2. If a sheath-core configuration is employed, the binder component should form the sheath.

Table 1, set forth below, summarizes the effect of adjusting proportions of the fiber component, cellulose component, and binder component upon various properties of the resulting batt.

TABLE I
Effect Upon Batt Properties
When Changing Component Proportions

| | |
|---|---|
| Increased % | Decreased % |

Fiber Component

| | |
|---|---|
| Moldability increases | Moldability decreases |
| Strength increases | Strength decreases |
| Density decreases | Density increases |
| Tackability increases | Tackability decreases |
| Flammability decreases | Flammability increases |
| Thermal properties decrease | Thermal properties increase |
| Acoustical properties decrease | Acoustical properties increase |
| Recycled content increases | Recycled content may decrease |
| Fiber orientation remains isotropic | Fiber orientation remains isotropic |

Cellulose Component

| | |
|---|---|
| Moldability decreases | Moldability increases |
| Strength decreases | Strength increases |
| Density increases | Density decreases |
| Tackability decreases | Tackability increases |
| Flammability increases | Flammability decreases |
| Thermal properties increase | Thermal properties decrease |
| Acoustical properties increase | Acoustical properties decrease |
| Recycled content increases | Recycled content may decrease |
| Fiber orientation remains isotropic | Fiber orientation remains isotropic |

Binder Component

| | |
|---|---|
| Moldability increases | Moldability decreases |
| Strength increases | Strength decreases |
| Density increases | Density increases |
| Tackability increases | Tackability decreases |
| Flammability decreases | Flammability increases |
| Thermal properties decrease | Thermal properties increase |
| Acoustical properties decrease | Acoustical properties increase |
| Recycled content decreases | Recycled content increases |
| Fiber orientation remains isotropic | Fiber orientation remains isotropic |

Referring again to FIG. 1, the finish material 18 of the preferred embodiment panel may be a layer made from any decorative membrane or thin material sheet, including fiber and non-fiber materials and woven and non-woven materials. Preferably, a thin layer of a metal such as aluminum foil is provided along one or both faces of the panel. Additional filler materials may also be added to enhance strength or other panel characteristics, such materials including, but not limited to, various thermoplastics such as polyester, co-polyester, and nylon; natural materials such as sisal, hemp, cotton and flax; or other materials such as ceramic powder, fire-retardant materials, or metal mesh. Specialized additives may also be added to improve certain properties of the finished panel, including but not limited to, pesticides, anti-microbial additives, ammonia dust inhibitors, stabilizers, and water repellants. As noted in certain applications, it is desirable to provide a thin metallic foil on one or both sides of the batt or molded formed product therefrom.

The preferred embodiment panels of the present invention are prepared as follows. Generally, the components as described herein are uniformly deposited onto a forming surface to form a loosely entangled non-woven fibrous web or batt and then shaped and bonded to form the final batt. Specifically, the fibers, cellulose, and binder components may be deposited onto a forming surface with a conventional carding process, e.g. a woolen or cotton carding process. The collection of components are then wet-laid or air-laid as known in the art. The fibers, cellulose, and binder components are mixed or otherwise dispersed with each other to form the resulting web or batt. The batt is then shaped or compressed to a desired density, heated and then cooled to thereby form interfiber bonds throughout the resulting batt. After forming the preferred embodiment batt, a panel or other product may be fashioned from the batt by one or more shaping and bonding processes which, for example may include a molding or thermoforming operation.

Bonding processes for forming the preferred embodiment batts include through-air bonding, hot-oven bonding and infrared-heater bonding processes. These processes may utilize a heating medium such as steam, heated air or gas, radiation, e.g., infrared light, and the like. Preferred bonding processes utilize through-air bonding operations. In this process, a flow of pressurized heated gas or air is driven through the batt to evenly and rapidly distribute heat throughout the batt. The duration and temperature of the bonding process can be varied to accommodate the temperature and speed limitations of the selected bonding equipment. However, it is important that the combination of duration and temperature of the bonding process is sufficiently long and high as to melt the binder component of the web but is not excessively long and high as to melt the fiber component, thereby preserving the physical and dimensional integrities and preventing shrinkage of the resulting batt.

Non-woven webs or batt, prior to any compression, suitable for the present invention typically have a density of about 500 g/m² to about 3,000 g/m² for a batt having a thickness of about 3 mm (0.12 inches) to about 220 mm (8.67 inches). The non-woven web or batt also exhibits desirable insulating properties. Preferably, the batt exhibits an R thermal insulation value of from about 3.0 to about 5.0. The batt also exhibits an acoustical range greater than 0.65 on the Noise Reduction Coefficient (NRC) scale as measured in accordance with ASTM standards.

Preferred embodiment panels according to the present invention exhibit densities of from about 40.06 kg/m³ (2.51 lbs/ft³) to about 237 kg/m³ (14.8 lbs/ft³). These values are of the panels after compression of the batt. It will be appreciated however, that the panels may undergo one or more additional compressing, molding, thermoforming or other operations that could further increase their density. As described in greater detail herein, the preferred embodiment batts and panels formed from such batts, exhibit remarkable fire-retardancy properties. In the Examples provided herein, panel samples according to the present invention were subjected to various fire tests according to ASTM E84 and UL 723. The preferred embodiment panels exhibited a flame-spread index of 25 or less, and a smoke index of 450 or less. These indices are determined according to ASTM E84 and UL 723.

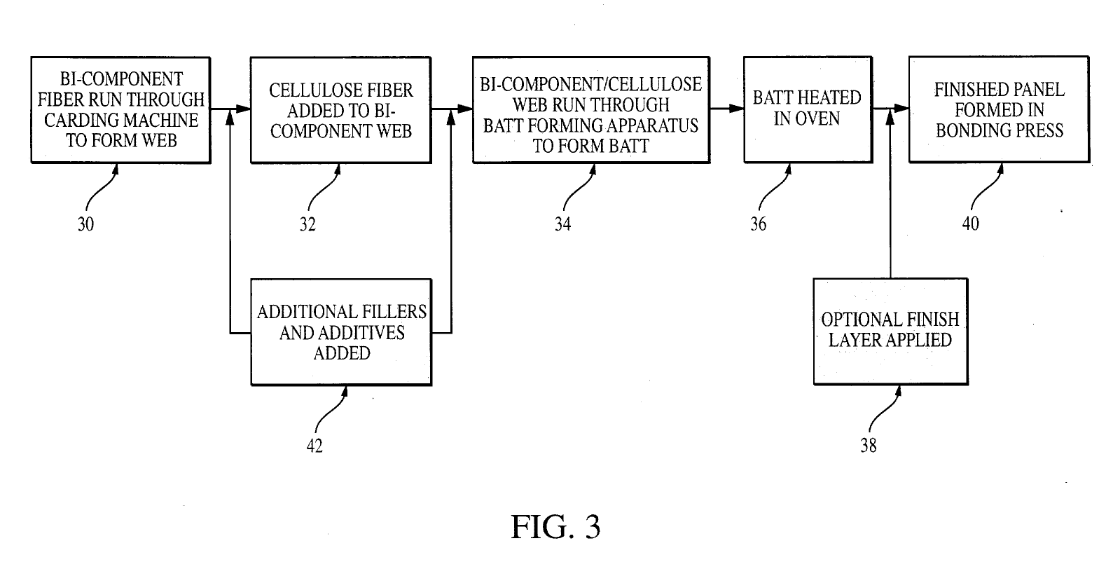

A preferred embodiment panel may be constructed using a conventional carding line and a batt forming apparatus in various arrangements. For convenience, a representative process will be described using a polyester bi-component fiber, a cellulose component and a finish layer only. As previously explained, however, various other processes may be used to produce the final panel. Furthermore, additional fibers, components, and additives may also be combined to produce the final panel. With reference to FIG. 3, the bi-component fiber 20 is introduced on a garnett or carding machine, designated as operation 30, which straightens and parallelizes the loosened bi-component fiber to form a web of parallel, crimped fibers. As the bi-component fiber web exits the carding machine, the treated cellulose component is spread out over the top of the web. This step is designated as operation 32. Any additional additives, such as pesticides or anti-microbial agents, may be added at this stage or prior to the forming of the web. This step is designated as operation 42. The resulting cellulose covered web is then directed through a batt forming apparatus, designated as operation 34, to build up the web into a batt and to integrate the cellulose with the bi-component fiber. The resulting batt is cut to width and then heated, designated as step 36, in an oven to melt the outer sheath 24 of the bi-component fiber (the binder polymer) and cause it to intimately blend the cellulose and the inner strand 22 of the bi-component fiber (the fiber). This provides a “through-bonded” batt that not only bonds the components of the panel, but also seals the surface of the batt against leakage. Any conventional carding machine and batt forming apparatus may be used in this process. A suitable batt forming apparatus is a Bemaformer™ available from Bematic. Although not preferred, it is contemplated that a cross lapper as known in the art could, in certain limited applications, be utilized for the batt forming apparatus.

Additionally, other known processes for forming batts may be used, such as those disclosed in U.S. Pat. Nos. 5,974,631; 6,263,545; and 6,276,028, the disclosures of which are incorporated herein by reference.

The batts are heated to a point where the binder polymer transitions from a solid state to a liquid state. Although the temperature at which the batts are heated will therefore vary depending on the composition of the fiber and binder component, a typical heating cycle using a polyester bi-component fiber includes heating the batts to about 204° C. (400° F.). Some of the binder component may liquefy while the remaining portion is in a transition or gel-like condition. Thus, the batt becomes soft and pliable, yet can still be handled because the fiber and cellulose retain enough of the batt structure. If the batts are to be molded into specific shapes to form a finished panel, the batts are transferred by a conveyor from an oven to a bonding press. If a finish layer 18 is to be used in the manufacture of the panel, it is transferred, designated as step 38 (see FIG. 3), from a fabric carousel to the bonding press at this stage. The finish layer is mated and aligned with the hot batt and the press is then closed, capturing and pressing the finish layer to bond it to and embed it in the batt.

Regardless of whether a finish layer is used, the bonding press is closed and the batt is pressed, designated as step 40, between the mold halves or dies of the press. The batt, still hot from the oven, assumes the shape of the interior of the press. The binder component may further transition to a molten state at this time due to the pressure of the press. The molten binder component flows throughout the mold cavity and binds the cellulose and fiber components together. If a finish layer is used, the molten material is also pressed into this layer, so it becomes at least partially embedded in the batt.

The mold halves or dies are preferably temperature controlled below the melting temperature of the binder component. Thus the oven heats the batt and the pressure of the closed mold in the press shapes the batt before the transfer of heat from the batt to the dies sets the batt in a solid state.

As discussed above, the binder component preferably at least partially melts to become a molten material during the heating in the oven. However, it preferably remains viscous rather than free-flowing. Thus, the binder component will only flow throughout the mold cavity when the press closes the mold and pressure is applied to the batt. Because of this, the final panel may have localized areas of relatively higher material density, and associated greater material toughness, where the added batt material was originally placed in the mold.

In a most preferred process according to the present invention, a molded product, i.e., panel, is formed from a batt as follows. A batt formulation is identified and appropriate fibers and materials for forming the batt are obtained. The desired fibers and materials are combined in the appropriate proportions, as described herein, and the materials are then mixed. The fibers and components may be mixed or otherwise intermingled as described herein. A relatively loose and lightweight batt is formed. Although batts of a wide array of dimensions and profiles may be prepared, the following example utilizes a batt having a height of about 200 mm (7.8 inches).

After preparing the batt, the batt is transported to an oven. Preferably this is carried out on a powered conveyor line. The batt is transferred to an oven or other heating chamber which heats the batt as described herein. The oven is a through-air oven and preferably passes air having a temperature of up to about 220° C. (428° F.) through one or more conveyor belts and the batt disposed thereon. It is contemplated that air having a temperature of from about 120° C. (248° F.) to about 250° C. (482° F.) could be used, depending upon the time period of heating. Immediately thereafter or concurrently with the initial through-air heating process, the batt is subjected to a slight to moderate compression operation. Preferably, the batt is positioned between two parallel and moving conveyor belts which compress the batt. During this compression, continued heating may occur, preferably by through-air heating.

Although a wide array of heating parameters may be used, the following parameters have been found desirable. The entire heating length in this initial heating and compressing stage is preferably 6.6 meters (21.6 feet). This, coupled with a conveyor belt speed of about 2.15 meters per minute, results in a residence time of about 3 minutes for the batt in the heating phase. It is contemplated that residence times of from about 1 minute to about 5 minutes could be used, however a range of from about 2 to about 4 minutes is preferred.

After passing through this first heating and compression stage, the relatively hot batt is then subjected to a first cooling operation. Preferably, relatively cool or low temperature air is passed through the batt in order to reduce its temperature.

Next, the cooled batt is then passed through a calender to adjust its thickness. Additionally, at this point one or more skins or other laminates may be added or otherwise applied to the batt.

Next, the previously heated and now cooled batt is subjected to a second heating and compression operation. Preferably, the batt is subjected to a second heating operation under the same conditions as previously described. Specifically, air having a temperature up to 220° C. (428° F.) is passed through the slightly to moderately compressed batt while the batt is traveling along a conveyor belt at a speed of about 2.15 meters per minute through a heating zone of about 7 meters (23 feet). During this second heating operation, the batt may be further compressed. Typically, this second compression stage is the stage at which the batt is compressed to its desired final thickness to form a panel according to the present invention.

After the second heating and compression stage, the panel is then subjected to a second cooling operation. Optionally, another, third, compression operation may be used to further compress the resulting panel if necessary.

The finally compressed and cooled panel is then subjected to a cutting operation. Typically, at this point the panel is now about 6.4 mm (0.25 inches) to about 12.8 mm (0.50 inches) thick.

This most preferred process utilizes a plurality of heating and compression steps as opposed to a single heating and compression step. Use of a plurality of steps, most preferably two heating steps and two or more compression steps, has been found to result in a significantly superior molded product as compared to a product formed from a molded batt using a single heating operation. Generally, products according to the present invention are significantly more stable and have better overall product characteristics and aesthetics than those resulting from a single heating process.

A suitable thermoforming process for the present invention is the mold-assist mold thermoforming process. A thermoformable laminate, or batt ready for panel formation, is heated to render the laminate, more specifically the non-woven batt, pliable using any known heating process that evenly heats the laminate. The heated, pliable laminate is placed over a male or female mold and assisted by a reciprocating assist mold that assists shaping the pliable laminate. Then the shaped laminate is cooled to allow the binder component of the laminate to set, permanently fixing the molded shape. The assist mold is designed to have a minimal surface contact with the laminate and is placed on the opposite side of the laminate away from the mold. The assist mold guides the pliable laminate to conform to the peripheral contour of the mold. The molds used in the processes of the present invention may, in certain applications not be heated and, desirably, are cooler than the temperature of the heated laminate to act as a heat sink, shortening the duration of the cooling cycle of the thermoformed article.

The molding process can be further assisted by pneumatic forces, such as vacuum or forced-air, that is applied on the pliable laminate to assist in the shaping process.

The furniture panel according to the present invention may be constructed using a single batt or a combination of different batts having different compositions. Thus, a manufacturer can produce panels having customized structures and properties based on a user's requirement criteria. The combining of different batts allows a fabricator to tailor the characteristics of the resulting panel by positioning desired layers of component materials or batts within the resulting panel. For example, a second batt comprised of a blend including a filler material may be used with a first batt to introduce and position a layer of filler material into the resulting panel of the invention. The second batt may be assembled using the same process described above, with an exception that fibers of a filler material are included in the blend. The first and second batts may be introduced to each other before or after they are heated in the oven. Preferably, the two batts are introduced prior to heating, so that they may become at least partially bonded together during heating by the melting and diffusion of the binder polymer between the two batts. The resulting layered structure may then be subjected to one or more suitable heating and shaping operations to form panels according to the present invention.

As noted, it should be realized that a panel of the invention may be constructed with various alternative “lay-ups” of different fiber and filler layers and multiple batts prior to molding in the bonding press. By selecting different components for use in the batt or a multiple number of batts or by changing the thickness of each batt, one may alter the stiffness, toughness, acoustics and other characteristics of the resulting panel of the invention. For example, strength and other panel characteristics may be enhanced with the use of metal or ceramic fibers added to the batt. A rigid support structure, such as a metal mesh or foil, may be embedded in the panel for additional strength by including the structure in the batt or web lay-up.

Structural characteristics of the panel may also be controlled by adjustment of the material density and the mold pressure. For a given amount of material, a defined mold cavity volume will result in a particular material density. With a constant mold cavity volume, increasing the amount of material in the batt will increase the resulting density in the final panel. A panel with a relatively higher material density will exhibit a greater toughness that resists puncturing. Conversely, decreasing the amount of material in the batt will produce a panel with a relatively lower material density, resulting in a lighter, less tough panel susceptible to puncturing and the insertion of pins and the like. Thus, for example, a furniture panel of the invention can be made to be a fully tackable panel by reducing the resulting material density appropriately. Such a panel can be constructed that allows papers or the like to be posted on the panel using pins or tacks.

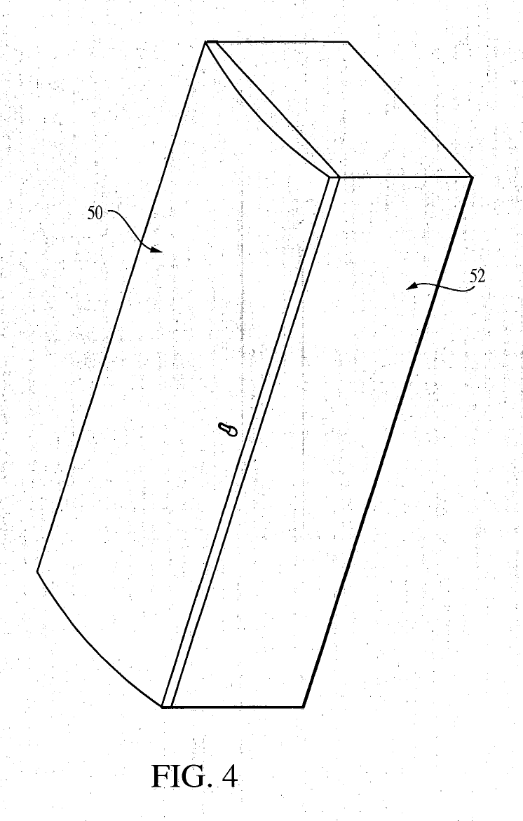

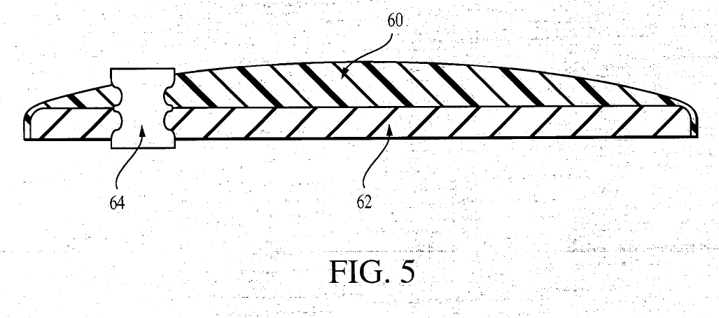

Various embodiments of the present invention panel can be constructed. For example, as shown in FIG. 4, a door 50 for a storage cabinet 52 can be formed. As noted above, the door 50 may be fabric finished. Alternatively, as shown in FIG. 5, the panel may be constructed as veneer piece 60 that overlays a pre-existing door 62. In this instance, the strength requirement for the panel will be minimal, since the panel will receive support from the underlying door 62. In both embodiments, the door 50 or veneer piece 60 may be equipped with embedded mounting brackets or fastening anchors 64. Plastic brackets or anchors 64 may be integrally formed with the panel by providing a high density of the batt in pre-selected localized areas. By providing a layer of moldable material of sufficient thickness, density and area, the panel may be molded with brackets or anchors in those areas. In published PCT application PCT/US00/32272, the disclosure of which is incorporated herein by reference, a method of forming furniture panels having a high quality appearance is disclosed in which a moldable material is melt-bonded to a finish fabric.

Additional panel pieces are also within the scope of the invention, including without limitation, wall panels, tack boards, seat back panels, storage cabinets, light shields, divider screens, privacy panels, and desk pieces. With the addition of anti-microbial agents, the panel pieces are especially useful in medical environments that require germ and microbial resistance, such as partition walls in hospital rooms. With the possible variations in weight, density, thickness and strength, other applications are contemplated as well.

In addition, the various components of the present invention can be used to form additional items besides panels, such as insulation. To form insulation rolls, instead of molding into panel pieces using a molding press, the cellulose component and bi-component fiber could be formed into lofty batts via a carding operation, with or without the use of a pressurized air source, such as disclosed in U.S. Pat. No. 5,873,964 to Kwok, the disclosure of which is incorporated herein by reference. Such a lofty batt is then placed into the oven, as described above, to at least partially melt the outer layer of the bi-component fiber and bond the components together. The bonded batt can be used as fire-resistant residential or commercial insulation possessing similar insulating properties as fiberglass without the health concerns.

The present invention fire-resistant moldable batt has a wide array of possible applications. The material can be formed into batting board stock, for example. Essentially, the material can be formed into nearly any three-dimensional structure. This provides a significant advantage over fiberglass or fiberglass composite materials since fiberglass often exhibits poor contouring or shape retaining properties. In contrast, the present invention materials exhibit excellent shape memory properties, are easily moldable, and have an additional benefit of fire retardancy. The materials satisfy the requirements of ASTM E84 and UL 723. These test standards are hereby incorporated by reference. The present invention materials also exhibit excellent acoustical, RF, and insulative properties. Essentially, the unique physical properties of the present invention materials allows their use in nearly any application that fiberglass could be utilized in. And so, the present invention materials are truly fiberglass replacements. The present invention materials may in addition be used instead of Styrofoam or other foamed materials. For example, the present invention materials could be used as board stock instead of Styrofoam. Generally, the webs, batts, and panels of the present invention can be used as board stock, roll stock, particularly for home or residential application, and may be molded into nearly any three-dimensional configuration.

### Testing

A series of trials were conducted to evaluate the fire-retardancy properties of preferred embodiment panels according to the present invention. In these tests, a relatively long, elongated test sample was ignited at one end. The distance of flame spread was monitored as a function of time. Additionally, the amount of smoke generated was measured, designated as the percent of obscuration, also as a function of time. From this data, a “Calculated Flame Spread” value and “Flame Spread Index” were determined in accordance with ASTM E84 and UL 723. All testing and test procedures were conducted according to these standards.

Samples 1 and 2 were molded panels formed in accordance with the present invention. The samples were formed from a batt comprising 70% Nu-Wool as the cellulose component and 30% of a bi-component fiber. Sample 1 was devoid of any protective covering or layer. Sample 2 included a thin aluminum foil layer on one side of the molded panel. Tables 2 and 3 summarize the data collected for samples 1 and 2, respectively.

TABLE 2
Sample 1
Steiner Tunnel
Flame Spread Testing

| | | | |
|---|---|---|---|
| Distance (ft.) | Time (sec) | Distance (ft.) | Time (sec) |

FLAME SPREAD RESULTS

| | | | |
|---|---|---|---|
| 0.00 | 4 | 4.50 | 174 |
| 0.50 | 12 | 2.00 | 314 |
| 1.00 | 14 | 3.00 | 391 |
| 2.00 | 18 | 4.00 | 410 |
| 3.00 | 25 | 5.00 | 463 |
| 3.50 | 37 | 6.00 | 553 |
| 4.00 | 96 | | |

| | |
|---|---|
| Calculated Flame Spread (CFS) | 22.78 |
| Flame Spread Index (FSI) | 25 |
| Duration of test: | 10 min. |
| Time to ignition | 4 sec |
| Maximum Flame Spread | 6 ft. prior to 10 min. |
| Actual area under the Flame spread Curve | 44.2 |
| (ft.-Min. | |

SMOKE RESULTS

| | |
|---|---|
| Calculated Smoke Developed (CSD) | 239.9 |
| Smoke Developed Index (SDI) | 250 |
| Area under the Smoke Curve: | 11.40 square inches |
| Area under the Red Oak Curve | 4.75 square inches |

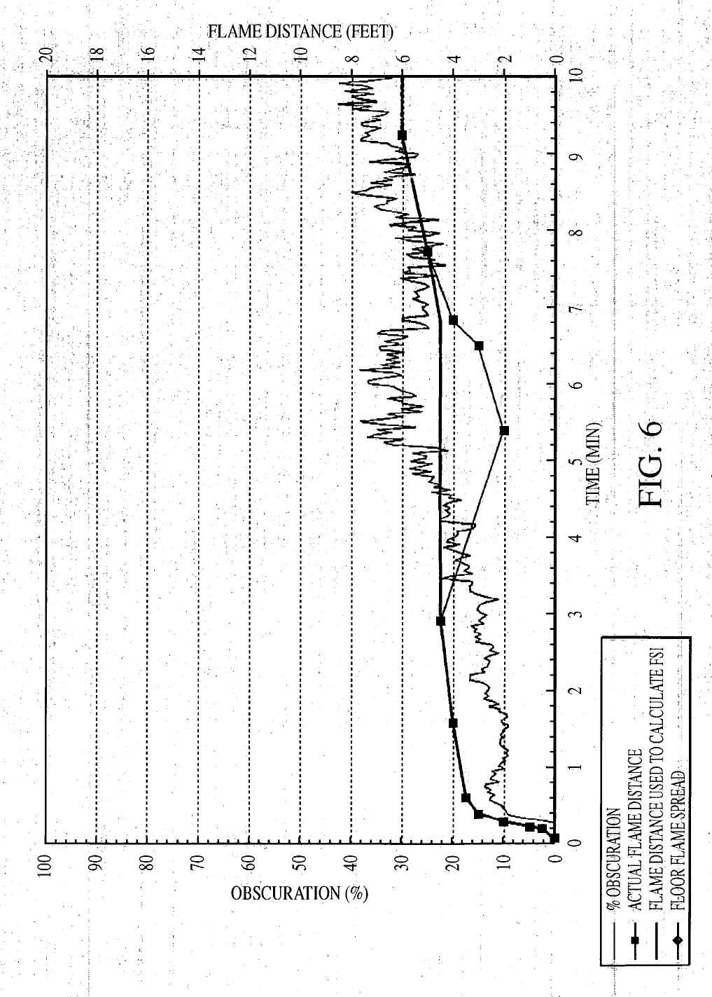

FIG. 6 graphically illustrates data collected in the Steiner Tunnel flame spread tests for sample 1.

TABLE 3
Sample 2
Steiner Tunnel
Flame Spread Testing

| | |
|---|---|
| Distance (ft.) | Time (sec) |

FLAME SPREAD RESULTS

| | |
|---|---|
| 0.00 | 4 |
| 0.50 | 16 |
| 1.00 | 283 |
| 1.50 | 320 |
| 0.50 | 545 |

| | |
|---|---|
| Calculated Flame Spread (CFS) | 5.22 |
| Flame Spread Index (FSI) | 5 |
| Duration of test: | 10 min. |
| Time to ignition | 4 sec |
| Maximum Flame Spread | 1.5 ft. prior to 10 min. |
| Actual area under the Flame spread | 10.1 |
| Curve (ft.-Min. | |

SMOKE RESULTS

| | |
|---|---|
| Calculated Smoke Developed (CSD) | 103.3 |
| Smoke Developed Index (SDI) | 105 |
| Area under the Smoke Curve: | 4.91 square inches |
| Area under the Red Oak Curve | 4.75 square inches |

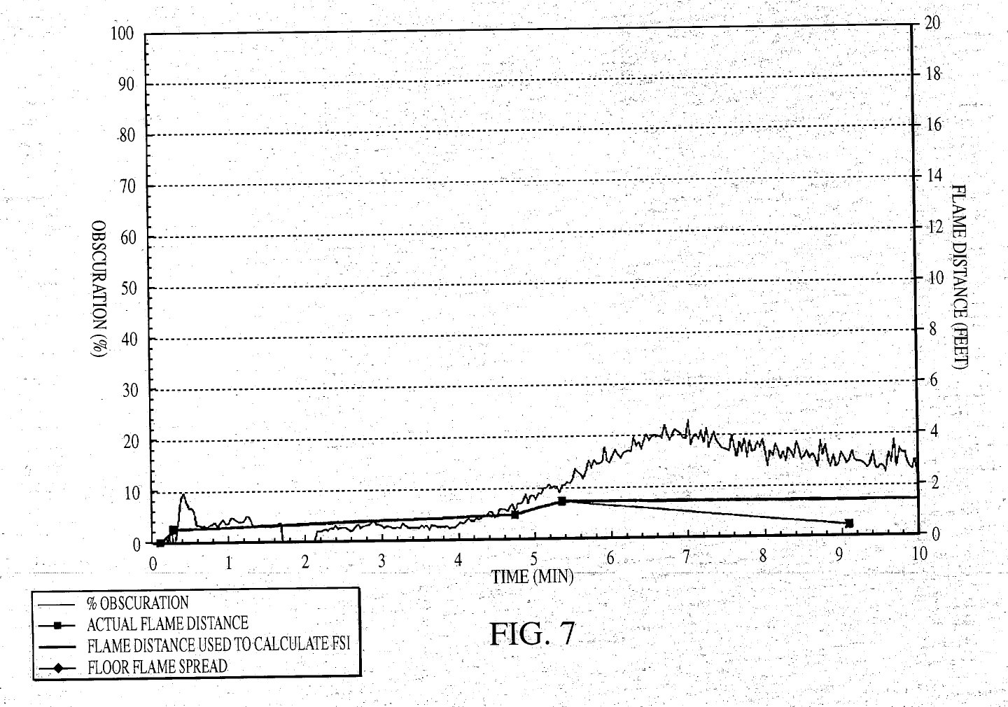

FIG. 7 graphically illustrates data collected in the Steiner Tunnel flame spread tests for Sample 2.

As previously noted, the preferred embodiment panels exhibit a flame spread index of 25 or less, and a smoke index of 450 or less. Sample 1 exhibited a flame spread index of 25 and a smoke index of 250. Sample 2 exhibited a flame spread index of 5 and a smoke index of 105. Referring to FIGS. 6 and 7 it will be noted that the actual flame distance for both samples decreased during burning. In Sample 1 shown in FIG. 6, at 3 minutes of burning the actual flame spread distance decreased from about 4.5 feet to about 2.0 feet at slightly after 5 minutes of burning. Similarly, in Sample 2, shown in FIG. 7, the flame distance decreased from about 1.5 feet at nearly 5 1/2 minutes of burn, to only 0.5 feet after about 9 minutes of burn.

Furthermore, the amount of smoke generated during these burns was remarkably low. Sample 1 produced smoke that resulted in a maximum obscuration of only about 40%, with the obscuration being significantly less than that during the majority of the burn time. Sample 2 exhibited even less smoke during burn, with a maximum obscuration of only about 20% after about 7 minutes of burning. It will be noted that the obscuration was less than 10% for about half of the burn time period. These relatively low levels of flame spread and smoke generation are a significant benefit of the panels and batts according to the present invention.

The foregoing description is, at present, considered to be the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

We claim:

1. A panel adapted for use in a furniture assembly, said panel comprising:
a first face;
a second face opposite said first face; and
a non-woven fibrous body disposed between said first and said second faces, said non-woven fibrous body including (i) from about 15% to about 60% of a fiber component dispersed throughout said body, (ii) from about 15% to about 85% of a fire-retardant cellulose component dispersed throughout said body, and (iii) from about 15% to about 70% of a binder component dispersed throughout said body, said body further including a plurality of fused regions of contact defined between adjacent portions of binder component resulting from prior heating of said body to a temperature sufficient to cause at least partial melting of said binder component and thereby fuse said adjacent portions of binder component;
said panel exhibiting a flame-spread index of 25 or less, and a smoke index of 450 or less.

2. The panel of claim 1 wherein said fiber component is selected from the group consisting of polyester, polyethylene terephthalate (PET), and combinations thereof.

3. The panel of claim 1 wherein said cellulose component is a fire-retardant cellulose material treated with an agent selected from the group consisting of boric acid, sodium polyborate, and combinations thereof.

4. The panel of claim 1 wherein said binder component is selected from the group consisting of polyester, polyethylene terephthalate (PET), polypropylene, polyethylene, nylon, polylactide, acrylic, and combinations thereof.

5. The panel of claim 4 wherein said binder component is a polyester fiber.

6. The panel of claim 4 wherein said binder component has a melting point of from about 100° C. (212° F.) to about 185° C. (365° F.).

7. The panel of claim 1 wherein said cellulose component constitutes from about 40% to about 70% of said non-woven fibrous body.

8. The panel of claim 7 wherein said cellulose component constitutes from about 45% to about 55% of said non-woven fibrous body.

9. The panel of claim 1 wherein said panel has a density of from about 65.7 kg/m³ (2.5 lbs/ft³) to about 237 kg/m³ (14.8 lbs/ft³).

10. The panel of claim 1 wherein said fiber component includes fibers having a diameter of from about 1.5 to about 66 denier.

11. The panel of claim 1 wherein said fiber component includes natural fibers selected from the group consisting of sisal fiber, jute fiber, kena fiber, coconut fiber, corn fiber, soybean fiber, wool fiber, cotton fiber, hemp fiber, and combinations thereof.

12. A panel adapted for use in a furniture assembly, said panel comprising:
a first surface;
a second surface opposite from said first surface; and
a non-woven fibrous body disposed between said first surface and said second surface, said non-woven fibrous body including (i) from about 40% to about 70% of a fire-retardant cellulose component dispersed throughout said body, and (ii) from about 30% to about 60% of a bi-component fiber, said bi-component fiber having an inner portion of a first thermoplastic and an outer portion of a second thermoplastic, said second thermoplastic having a melting temperature less than the melting temperature of said first thermoplastic, said body further including a plurality of fused regions of contact defined between adjacent bi-component fibers resulting from prior heating of said body to a temperature greater than said melting temperature of said second thermoplastic;
said panel having fire-retardancy properties such that said panel exhibits a flame-spread index of 25 or less and a smoke index of 450 or less.

13. The panel of claim 12 wherein said first thermoplastic is selected from the group consisting of polyester, polyethylene terephthalate (PET), and combinations thereof.

14. The panel of claim 12 wherein said cellulose component is a fire-retardant cellulose fiber treated with either boric acid or sodium polyborate.

15. The panel of claim 12 wherein said second thermoplastic is selected from the group consisting of polyester, polyethylene terephthalate (PET), polypropylene, polyethylene, nylon, polylactide, acrylic, and combinations thereof.

16. The panel of claim 12 wherein said second thermoplastic has a melting point of from about 100° C. (212° F.) to about 185° C. (365° F.).

17. The panel of claim 12 wherein said cellulose component constitutes from about 45% to about 55% of said non-woven fibrous body.

18. The panel of claim 12 wherein said second thermoplastic constitutes from about 20% to about 80% of said bi-component fiber.

19. The panel of claim 18 wherein said second thermoplastic constitutes from about 40% to about 60% of said bi-component fiber.

20. The panel of claim 19 wherein said second thermoplastic constitutes about 50% of said bi-component fiber.

21. The panel of claim 12 wherein said panel has a density of from about 65.7 kg/m³ (2.5 lbs/ft³) to about 237 kg/m³ (14.8 lbs/ft³).

22. The panel of claim 12 wherein said bi-component fiber has a diameter of from about 1.5 to about 9 denier.

23. The panel of claim 12 wherein the temperature difference between the melting point of said first thermoplastic and the melting point of said second thermoplastic is at least about 5° C. (9° F.).

24. The panel of claim 23 wherein said temperature difference is at least about 10° C. (18° F.).

25. The panel of claim 24 wherein said temperature difference is at least about 25° C. (45° F.).

26. The panel of claim 12 wherein said bi-component fiber has a density of from about 1.25 g/cm³ to about 1.33 g/cm³.

27. A fire-resistant moldable batt comprising:
(i) from about 15% to about 60% of a fiber component;
(ii) from about 15% to about 85% of a fire-retardant cellulose component, said cellulose component treated with at least one of boric acid or sodium polyborate; and
(iii) from about 15% to about 70% of a binder component, said binder component being a thermoplastic having a melting point of from about 100° C. (212° F.) to about 185° C. (365° F.).

28. The batt of claim 27 wherein said fiber component has a diameter of from about 1.5 to about 66 denier.

29. The batt of claim 27 wherein said cellulose component constitutes from about 40% to about 70% of said batt.

30. The batt of claim 29 wherein said cellulose component constitutes from about 45% to about 55% of said batt.

31. The batt of claim 27 wherein said fiber component and said binder component are in a bi-component fiber.

32. The batt of claim 31 wherein said bi-component fiber constitutes from about 40% to about 70% of said batt.

33. The batt of claim 31 wherein said bi-component fiber has a diameter of from about 1.5 to about 9 denier.

34. The batt of claim 31 wherein said bi-component fiber has a density of from about 1.25 g/cm³ to about 1.33 g/cm³.

35. The batt of claim 31 wherein said bi-component fiber has a side-by-side configuration.

36. The batt of claim 31 wherein said bi-component fiber has a sheath-core configuration.

37. A process for producing a panel, said process comprising:
providing from about 15% to about 60% by weight of said panel of a fiber component;
providing from about 15% to about 85% by weight of said panel of a fire-retardant cellulose component;
providing from about 15% to about 70% by weight of said panel of a binder component;
dispersing together said fiber component, said cellulose component, and said binder component to form a non-woven fibrous batt having a plurality of regions of contact between adjacent portions of binder component;
forming said non-woven fibrous batt by compressing said batt to a density of from about 2.5 lbs/ft³ to about 14.8 lbs/ft³, and heating said batt to a temperature greater than the melting temperature of said binder component to thereby fuse together said regions of contact between adjacent binder portions and form said panel.

38. The process of claim 37 wherein said forming step includes:
moving said batt through a heating chamber such that said batt is retained within said chamber for a period of from about 2 minutes to about 4 minutes, while passing air having a temperature of from about 120° C. (248° F.) to about 250° C. (482° F.) through said batt.

39. The process of claim 38 wherein said batt is retained within said chamber for about 3 minutes while air having a temperature of about 220° F. (428° F.) is passed through said batt.

40. The process of claim 37 wherein said forming step includes:
a first heating step in which at least a portion of said binder component melts in said batt;
a first cooling step after said first heating step in which said binder component solidifies;
a second heating step after said first cooling step in which a portion of said binder component melts in said batt; and
a second cooling step after said second heating step in which said binder component solidifies.

41. The process of claim 40 in which during at least one of said first and second heating steps, air having a temperature of from about 120° C. (248° F.) to about 250° C. (482° F.) is passed through said batt.

42. The process of claim 41 wherein said air is at a temperature about 220° C. (428° F.).

43. The process of claim 37 wherein said step of providing a fire-retardant cellulose component is performed by providing cellulose treated with at least one of boric acid or sodium polyborate.

44. The process of claim 43 wherein said step of providing said fire-retardant cellulose is performed by providing from about 40% to about 70% of said cellulose, by weight of said batt.

45. The process of claim 37 wherein said steps of providing said fiber component and said binder component are performed by providing an effective amount of a bi-component fiber containing such components.

46. The process of claim 37 wherein said step of forming said batt by compressing and heating said batt includes compressing said batt into said panel having a thickness of from about 6.4 mm (0.25 inches) to about 12.8 mm (0.50 inches).

47. A process for producing a panel, said process comprising:
providing from about 40% to about 70% by weight of said panel of a cellulose component;
providing from about 30% to about 60% by weight of said panel of a conjugate fiber, said conjugate fiber having a first portion of a first thermoplastic and a second portion of a second thermoplastic having a melting temperature less than the melting temperature of said first thermoplastic;
dispersing together said cellulose component and said conjugate fiber to form a non-woven fibrous batt having a plurality of regions of contact between adjacent conjugate fibers;
heating and compressing said non-woven fibrous batt by compressing said batt to a density of from about 2.5 lbs/ft³ to about 14.8 lbs/ft³, and a temperature greater than the melting temperature of said second thermoplastic to thereby fuse together said regions of contact between adjacent conjugate fibers and form said panel.

48. The process of claim 47 wherein said heating step includes:
moving said batt through a heating chamber such that said batt is retained within said chamber for a period of from about 2 minutes to about 4 minutes, while passing air having a temperature of from about 120° C. (248° F.) to about 250° C. (482° F.) through said batt.

49. The process of claim 48 wherein said batt is retained within said chamber for about 3 minutes while air having a temperature of about 220° F. (428° F.) is passed through said batt.

50. The process of claim 47 wherein said heating step includes:
a first heating step in which at least a portion of said second thermoplastic melts in said batt;
a first cooling step after said first heating step in which said second thermoplastic solidifies;
a second heating step after said first cooling step in which a portion of said second thermoplastic melts in said batt; and
a second cooling step after said second heating step in which said second thermoplastic solidifies.

51. The process of claim 50 in which during at least one of said first and second heating steps, air having a temperature of from about 120° C. (248° F.) to about 250° C. (482° F.) is passed through said batt.

52. The process of claim 51 wherein said air is at a temperature about 220° C. (428° F.).

53. The process of claim 47 wherein said step of providing said cellulose component is performed by providing cellulose treated with at least one of boric acid and sodium polyborate.

54. The process of claim 47 wherein said steps of heating and compressing said batt includes compressing said batt into said panel having a thickness of from about 6.4 mm (0.25 inches) to about 12.8 mm (0.50 inches).
